(19) United States
(12) Patent Application Publication
(10) Pub. No.: US 2011/0106893 A1
(43) Pub. Date: May 5, 2011

(54) Active Email Spam Prevention

(76) Inventor: Chi Hong Le, Liverpool, NY (US)

(21) Appl. No.: 12/611,099

(22) Filed: Nov. 2, 2009

(51) Int. Cl. G06F 15/16

(52) U.S. Cl. 709/206

(57) ABSTRACT

Active email spam prevention is not let email spam contents or block spammer send to mail server that is distributed to recipients.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

### Field of Invention

This invention relates generally to computer algorithm, email spam filters are in present applications on server is passive mode, the spam emails are already on mail server. While active email spam prevention put the sender in the loop, without the human, the email or packets contend will not be sent.

### BRIEF SUMMARY OF THE INVENTION

People are very upset when see the inbox full of spam email, even turn on spam filter, then spam folder store most the spam email. Therefore, have a lot wasteful resource as electric, traffic network, time of email reader.

The most effective to save resource of electric, traffic network, time of email reader that prevent spam email from beginning. Put email sender in the loop, the system makes sure the sender is a real human, not run by program or script. The system will check each recipient address, if email sender on the spam list or the first time send to receiver emails, then system generate as many as icon image send to the sender, request sender enter to verify. If verify are correct, then the system accept the email contents are send from the sender.

### BRIEF DESCRIPTION OF THE SEVERAL VIEWS OF THE DRAWING

FIG. 1 is the flow chart of active email spam prevention between client and server.

Recipients addresses are send to server, if the first time sends to recipients or in the block list of recipients, server is generated icon images send to client. Otherwise, allow client send content to server.

Sender enters characters in the icon images, if matching characters in server, then accept client send content to server. Otherwise, server tracking errors, then server is created a new set icon images send to client. If errors repeated many times, then server blocks the client IP address.

### DETAILED DESCRIPTION OF THE INVENTION

Algorithms to prevent email spam by make sure the email sender is human, not run by script or program. First, the client email send address recipients to server, then server check the addresses are block by recipients or the first time send to recipients. Second, the server create icon images send back to the client, then the sender manually enter the characters one by one on the icon images. Third, the server checks the characters are corrected or not, if they are corrected, then the server let client send email contents to server, otherwise, server will create the other set of icon images send to the client. If have many errors repeat, then server will block the IP address of client.

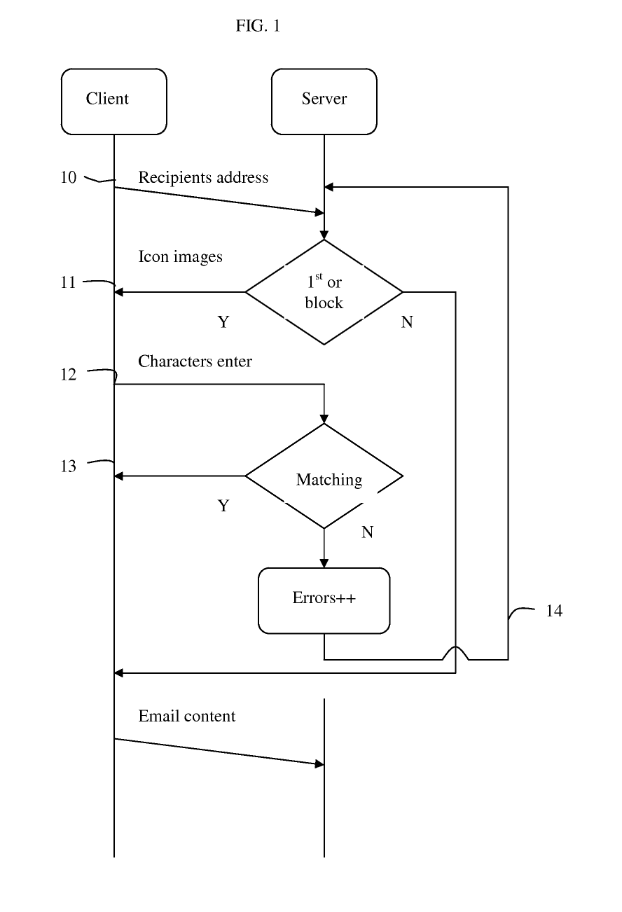

FIG. 1 is the flow chart of active email spam prevention between client and server. Label 10 is client send recipients address to mail server. Label 11 is client receive icon images from server. Label 12 is human enter characters. Label 13 is server allow client send content of email to server. Label 14 is potential email spam.

Recipients addresses are send to server, if the first time sends to recipients or in the block list of recipients, server is generated icon images send to client. Otherwise, allow client send content to server.

Sender enters characters in the icon images, if matching characters in server, then accept client send content to server. Otherwise, server tracking errors, then server is created a new set icon images send to client. If errors repeated many times, then server blocks the client IP address.

What I claim as my invention is:

1. Put human in the loop to send email.
Prevent spammer scripts and/or program to send email.
